(19) United States
(12) Patent Application Publication
(10) Pub. No.: US 2006/0259762 A1
(43) Pub. Date: Nov. 16, 2006

(54) E-mail server device and certificate management method of the e-mail server device

(75) Inventor: Yoshifumi Tanimoto, Hirakata-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/400,389

(22) Filed: Apr. 10, 2006

(30) Foreign Application Priority Data
May 13, 2005 (JP) 2005-140710

(51) Int. Cl. H04L 9/00

(52) U.S. Cl. 713/156

(57) ABSTRACT

An e-mail server device includes a certificate storage unit, an SMTP reception unit, a signature unit, an SMTP transmission unit, a validity determination unit and an update request e-mail generating unit. The certificate storage unit stores a certificate for each account. The SMTP reception unit receives e-mail. The signature unit assigns a digital signature to the e-mail received by the SMTP reception unit by using a certificate of an account of a transmitter. The SMTP transmission unit transfers the e-mail assigned with the digital signature. The validity determination unit determines whether or not the certificate stored in the certificate storage unit is necessary to be updated. When the validity determination unit determines that the certificate is necessary to be updated, the update request e-mail generating unit transmits update request e-mail to the account for requesting an update of the certificate.

### BACKGROUND OF THE INVENTION

1. Field of the Invention

The present invention relates to an electronic mail (hereinafter “e-mail”) server device and a certificate management method of the e-mail server device. In particular, the present invention relates to an e-mail server device, which manages a certificate by substituting a client, and a certificate management method of the e-mail server device.

2. Description of the Related Art

A conventional e-mail server executes a process necessary for using a Public Key Infrastructure (PKI) by substituting a client. For example, the process includes an encryption of e-mail, a digital signature, and an addition of an electronic certificate. The e-mail server confirms the validity of a digital certificate. When the digital certificate is determined to be invalid, the e-mail server deletes the digital certificate registered in a database.

However, in the conventional art, when the digital certificate is invalid, a digital signature cannot be assigned to an e-mail by using the invalid digital certificate. Thus, there exists room for improvement.

### SUMMARY OF THE INVENTION

In order to overcome the problems described above, an advantage of the present invention is to provide an e-mail server device which can easily carry out a management as to whether or not an update of a digital certificate is necessary, thus being highly convenient and having highly reliable security.

According to a preferred aspect of the present invention, an e-mail server device includes a certificate storage unit, a reception unit, a digital signature unit, a transfer unit, a determination unit and an update requesting unit. The certificate storage unit stores a digital certificate for each account. The reception unit receives e-mail. The digital signature unit assigns a digital signature to the e-mail received by the reception unit by using the digital certificate of an account of a transmitter. The transfer unit transfers the e-mail assigned with the digital signature. The determination unit determines the necessity of updating the digital certificate stored in the certificate storage unit. When the determination unit determines that it is necessary to updated the digital certificate, the update requesting unit requests the account to update the digital certificate.

For example, the determination unit can determine the necessity of the update in accordance with whether the digital certificate is valid or invalid. The determination unit can determine validity of the digital certificate in accordance with an expiration date and/or a presence or an absence of a lapse of the digital certificate. That is, the determination unit can determine whether the digital certificate is valid or invalid according to whether or not the digital certificate has expired. A determination as to whether or not the digital certificate has expired can be made by comparing a present date and time with the expiration date of the digital certificate. Moreover, the determination unit can determine whether or not the digital certificate is valid or invalid according to whether or not the digital certificate has lapsed. For example, even when the digital certificate is within an effective period, if the digital certificate has lapsed, the determination unit determines that the digital certificate is invalid.

A confirmation of the expiration date of the digital certificate by the determination unit can be carried out periodically. The confirmation can be carried out at transmission and/or reception of e-mail. Alternatively, the confirmation can be carried out according to a request of a user. Further, a client of an account, which has received update request e-mail, can transmit a new digital certificate to the e-mail server device.

The e-mail server device includes a function for automatically formatting transmission e-mail by assigning a digital signature and transmitting the e-mail by substituting a client. The e-mail server device can assign the digital signature by using the digital certificate. The e-mail server device can automatically carry out a management of an effective period and validity of the digital certificate. Thus, the client is not required to carry out the management of the digital certificate. Accordingly, the preferred aspect of the present invention provides an e-mail server device having high convenience and highly reliable security.

The determination unit can determine the necessity of the update according to whether or not a remaining length of the effective period of the digital certificate is a prescribed length or shorter. When the remaining length of the effective period of the digital certificate is the prescribed length or shorter, the determination unit determines that the update is necessary. When the determination unit determines that the update of the digital certificate is necessary, the update requesting unit transmits update request e-mail to the account for requesting the update of the digital certificate.

The e-mail server device includes a function for automatically formatting transmission e-mail by assigning a digital signature and transmitting the e-mail by substituting a client. The e-mail server device can assign the digital signature by using the digital certificate. The e-mail server device can automatically carry out a management of the effective period of the digital certificate. Thus, the client is not required to carry out the management of the digital certificate. Accordingly, the preferred aspect of the present invention provides an e-mail server device having high convenience and highly reliable security.

The e-mail server device may further include an update accepting unit and an updating unit. The update accepting unit accepts an update instruction of the digital certificate by e-mail. When the update accepting unit accepts the update instruction, the updating unit updates the digital certificate stored in the certificate storage unit.

The update accepting unit can determine whether or not the received e-mail includes an update instruction of the digital certificate in accordance with an identity of an account of a transmitter and an account of a destination in the received e-mail and a presence or an absence of the digital certificate in the received e-mail. That is, the update accepting unit can determine whether or not the received e-mail is update instruction e-mail for the digital signature in accordance with whether or not the account of the transmitter is the same as the account of the destination in the received e-mail and whether or not the digital certificate of the client is attached to the received e-mail.

As another determination method, the update accepting unit can determine whether or not the received e-mail includes an update instruction of the digital certificate in accordance with a destination e-mail address of the received e-mail and a presence or an absence of the digital certificate in the received e-mail. That is, the update accepting unit can determine whether or not the received e-mail is the update instruction e-mail of the digital signature in accordance with whether or not the destination of the received e-mail is a prescribed e-mail address and whether or not the digital signature of the client is attached to the received e-mail.

The e-mail server device further includes a determination unit and a certificate accepting unit. The determination unit determines whether or not the e-mail accepted by the update accepting unit includes an update instruction of the digital certificate. The certificate accepting unit accepts a new digital certificate attached to the e-mail. The updating unit updates the digital certificate stored in the certificate storage unit with the new digital certificate in accordance with the update instruction.

According to this constitution, just by transmitting the e-mail with the digital signature from each client to the e-mail server device, the digital certificate stored in the e-mail server device can be updated automatically. As a result, usability improves.

The e-mail server device further includes an update notification unit. The update notification unit transmits update notification e-mail to the account to notify that the updating unit has updated the digital certificate.

According to this constitution, by receiving the update notification e-mail transmitted automatically from the e-mail server device, the client can learn an update period of the digital certificate. Thus, convenience improves.

Further, any combinations of the above-described constituent elements and the conversions of the expression of the present invention between a method, a device, a system, a recording medium, a computer program or the like are also effective as a preferred embodiment of the present invention.

According to the present invention, the management of the validity of the digital certificate can be carried out easily, and the e-mail server device results being highly convenient and having highly reliable security.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a functional block diagram illustrating a configuration of an e-mail server device according to a preferred embodiment of the present invention.

FIG. 2 illustrates an example of a configuration of a certificate storage unit of the e-mail server device according to a preferred embodiment of the present invention.

FIG. 3 illustrates an example of a structure of a certificate of the e-mail server device according to a preferred embodiment of the present invention.

FIG. 4 is a functional block diagram illustrating a Simple Mail Transfer Protocol (SMTP) reception unit of the e-mail server device according to a preferred embodiment of the present invention.

FIG. 5 is a flowchart illustrating an example of an operation performed for managing an expiration date of a certificate by the e-mail server device according to a preferred embodiment of the present invention.

FIG. 6 is a flowchart illustrating an example of an operation performed at SMTP reception of transmission e-mail by the e-mail server device according to a preferred embodiment of the present invention.

FIG. 7 is a flowchart illustrating an example of an operation performed at transfer of e-mail by the e-mail server device according to a preferred embodiment of the present invention.

### DETAILED DESCRIPTION OF PREFERRED EMBODIMENTS

With reference to the drawings, a description will be made of preferred embodiments of the present invention. Further, like numeral is applied to like constituent element and a description is omitted as appropriate.

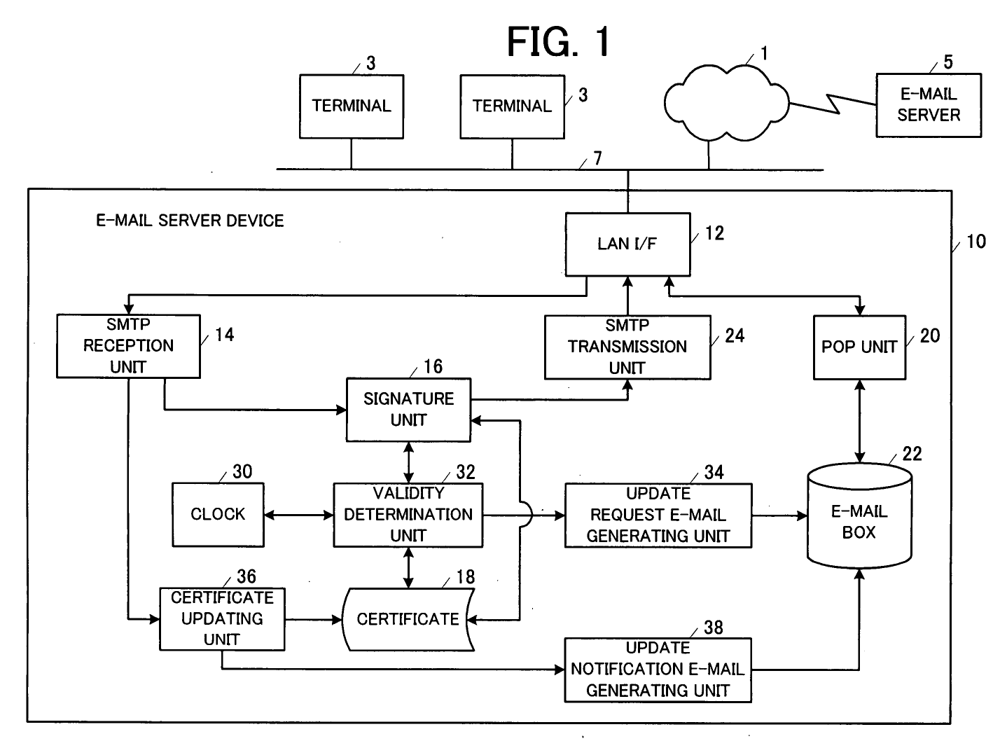

FIG. 1 is a functional block diagram illustrating a configuration of an e-mail server device according to a preferred embodiment of the present invention. The e-mail server device of the present preferred embodiment (an e-mail server device 10) includes a certificate storage unit (a certificate storage unit 18), a reception unit (an SMTP reception unit 14 and a Local Area Network (LAN) interface unit 12), a digital signature unit (a signature unit 16), a transfer unit (an SMTP transmission unit 24 and the LAN interface unit 12), a determination unit (a validity determination unit 32), and an update requesting unit (an update request e-mail generating unit 34).

The certificate storage unit (the certificate storage unit 18) stores a certificate 40 for each account. The reception unit (the SMTP reception unit 14 and the LAN interface unit 12) receives e-mail. The digital signature unit (the signature unit 16) assigns a digital signature to the e-mail received by the reception unit by using the certificate 40 of an account of a transmitter. The transfer unit (the SMTP transmission unit 14 and the LAN interface unit 12) transfers the e-mail assigned with the digital signature. The determination unit (the validity determination unit 32) determines whether the certificate 40 stored in the certificate storage unit 18 is valid or invalid. When the determination unit determines that the certificate 40 is invalid, the update requesting unit (the update request e-mail generating unit 34) transmits update request e-mail requesting an update of the certificate 40 to the account.

For example, the e-mail server device 10 is connected to a network such as the Internet 1 via a network such as a LAN 7. The e-mail server device 10 functions as an SMTP server and a Post Office Protocol (POP) server for a plurality of terminals 3 connected to the LAN 7. Alternatively, the e-mail server device 10 may be included in an extension board connected via the LAN 7 to a main body of a network scanner, an Internet facsimile machine, a Multi Functional Peripheral (MFP) or the like. Further, a constitution of a part unrelated to the subject matter of the present invention is omitted in FIG. 1.

Each constituent element of the e-mail server device 10 is realized by an arbitrary combination of hardware and software primarily by a Central Processing Unit (CPU) of any computer, a memory, a program which realizes the constituent elements illustrated in FIG. 1 loaded to the memory, a storage unit such as a hard disk drive which stores the program, and an interface for establishing a connection with a network. It is understood by those skilled in the art that various changes and modifications can be made to methods and devices for realizing each of the constituent elements of the e-mail server device 10. Each of the drawings to be described hereinafter shows blocks representing units of function, instead of units of hardware.

As illustrated in FIG. 1, the e-mail server. device 10 includes the LAN interface unit 12 (in the drawing, “LAN I/F”), the SMTP reception unit 14, the signature unit 16, the certificate storage unit 18 (in the drawing, “certificate”), a POP unit 20, an e-mail box 22, the SMTP transmission unit 24, a clock 30, the validity determination unit 32, the update request e-mail generating unit 34, a certificate updating unit 36, and an the update notification e-mail generating unit 38.

The LAN interface unit 12 carries out communication with a plurality of terminals 3 via the LAN 7 and carries out communication with another e-mail server 5 via the Internet 1. The SMTP reception unit 14 receives e-mail from the terminals 3 on the LAN 7 via the LAN interface unit 12. The e-mail received here includes e-mail transmitted from each terminal 3 to another terminal 3 on the LAN 7 or a terminal (not illustrated) on the Internet 1, and e-mail addressed to the e-mail server device 10. The e-mail addressed to the e-mail server device 10 will be described later.

The signature unit 16 assigns a digital signature to the e-mail received by the SMTP reception unit 14 by using the certificate stored in the certificate storage unit 18. That is, the signature unit 16 accesses the certificate storage unit 18, and acquires certificate registration information associated with an account of a transmitter of the e-mail received by the SMTP reception unit 14. Then, the signature unit 16 determines whether or not the certificate 40 is registered. When the certificate 40 is not registered, the signature unit 16 directly passes the received transmission e-mail to the SMTP transmission unit 24. Meanwhile, when the certificate 40 is registered, the signature unit 16 instructs a digital signature by using the certificate 40.

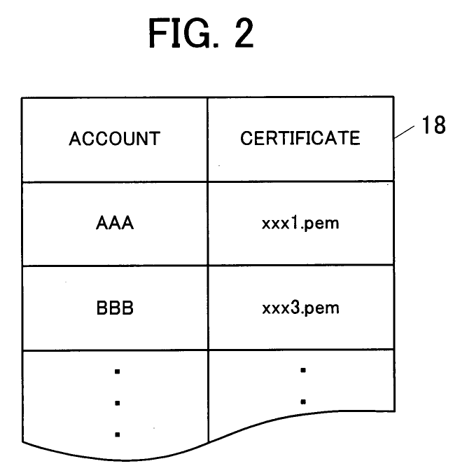

The certificate storage unit 18 stores the certificate 40 of each account. As illustrated in FIG. 2, in the present preferred embodiment, the certificate storage unit 18 stores the certificate registration information by associating the certificate registration information with each account. Further, the certificate 40 is not necessarily required to be stored in the certificate storage unit 18. That is, the certificate 40 may be stored in another storage device, and the certificate storage unit 18 may store a file name or a storage location address of the certificate 40 by associating with the account.

Referring to FIG. 1 again, the POP unit 20 receives e-mail addressed to each terminal 3 on the LAN 7 via the LAN interface unit 12. The e-mail received by the POP unit 20 is stored into the e-mail box 22 for each account of the terminal 3. The terminal 3 accesses the e-mail box 22 via the LAN interface unit 12. Accordingly, the terminal 3 receives the e-mail stored in the e-mail box 22. The e-mail stored in the e-mail box 22 is stored temporarily until the terminal 3 receives the e-mail. Then, the e-mail is deleted according to a request of the terminal 3.

The e-mail box 22 also stores e-mail addressed to the terminal 3 created by the update request e-mail generating unit 34 and the update notification e-mail generating unit 38 described later. The terminal 3 receives these e-mails by accessing the e-mail box 22.

The SMTP transmission unit 24 receives the e-mail, which has been received by the SMTP reception unit 14, via the signature unit 16. The SMTP transmission unit 24 transfers the e-mail via the LAN interface unit 12 to another e-mail server 5 on the Internet 1 corresponding to a destination of the e-mail.

The clock 30 clocks present time. The validity determination unit 32 confirms an expiration date included in the certificate 40 stored in the certificate storage unit 18 for each account to determine whether the certificate 40 is valid or invalid. When the validity determination unit 32 determines that the certificate 40 is invalid, the update request e-mail generating unit 34 creates update request e-mail for requesting an update of the certificate 40 and stores the created update request e-mail into the e-mail box 22 of such an account.

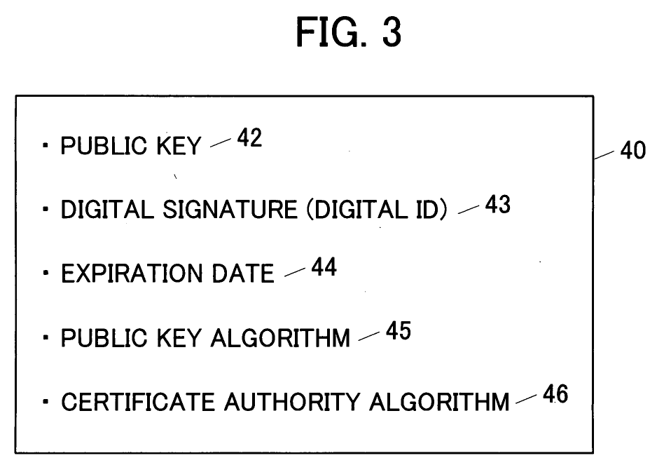

FIG. 3 illustrates an example of a structure of the certificate 40 of the e-mail server device 10 according to the present preferred embodiment. In the present preferred embodiment, the certificate 40 includes a public key 42, a digital signature 43, an expiration date 44, a public key algorithm 45 and a certificate authority algorithm 46.

In the present preferred embodiment, the validity determination unit 32 of FIG. 1 confirms the expiration date 44 of the certificate 40 of FIG. 3 and determines whether the certificate 40 is valid or invalid. That is, the validity determination unit 32 accesses the clock 30 to acquire the present date and time, and compares the acquired present date and time with the expiration date 44 of the certificate 40 to determine the validity of the certificate 40. For example, when the present date and time is past the expiration date 44, the validity determination unit 32 determines that the certificate 40 is invalid due to expiration. The validity determination unit 32 also determines the validity of the certificate 40 according to a presence or an absence of a lapse of the certificate 40. When the certificate 40 has already lapsed, the validity determination unit 32 determines that the certificate 40 is invalid even if the certificate 40 is within an effective period, for example.

Instead of determining whether the certificate 40 is valid or invalid, the validity determination unit 32 may determine whether or not the present date and time is a prescribed number of days before the expiration date 44 of the certificate 40. That is, the validity determination unit 32 may determine whether or not the expiration date 44 of the certificate 40 arrives within a prescribed number of days from the present date and time.

The validity determination unit 32 can periodically carry out a confirmation of the expiration date 44 and/or a presence or an absence of a lapse of the certificate 40. Alternatively, the validity determination unit 32 can carry out the confirmation of the expiration date 44 and/or a presence or an absence of a lapse of the certificate 40 at transmission and/or reception of e-mail. As another example, the validity determination unit 32 can carry out the confirmation of the expiration date 44 and/or a presence or an absence of a lapse of the certificate 40 according to a request of a user.

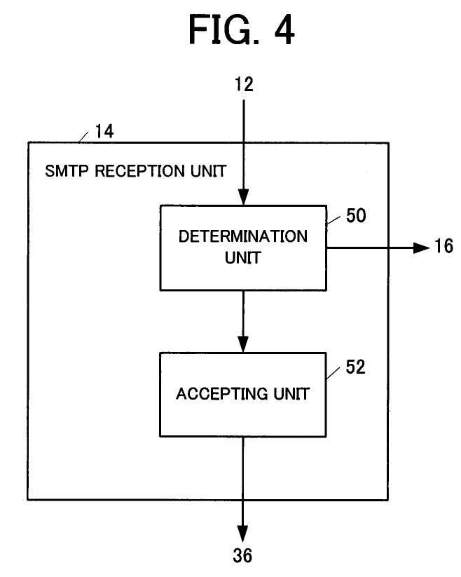

FIG. 4 is a functional block diagram illustrating details of the SMTP reception unit 14 of the e-mail server device 10 according to the present preferred embodiment of the present invention. The SMTP reception unit 14 of the e-mail server device 10 includes a determination unit 50 and an accepting unit 52.

The determination unit 50 determines whether or not the e-mail received by the SMTP reception unit 14 includes an update instruction for the certificate 40. For example, the determination unit 50 determines whether or not the received e-mail includes the update instruction for the certificate 40 in accordance with an identity of an account of a transmitter and an account of a destination in the received e-mail and whether or not a certificate of a client is attached to the received e-mail. That is, when the account of the transmitter and the account of the destination in the received e-mail are the same and the certificate of the client is attached to the received e-mail, the determination unit 50 determines that the received e-mail includes the update instruction for the certificate 40.

As another determination method, the determination unit 50 determines whether or not the received e-mail includes the update instruction for the certificate 40 in accordance with a destination e-mail address of the received e-mail and whether or not the certificate of the client is attached to the received e-mail. That is, when a destination of the received e-mail is a prescribed e-mail address exclusive for the update instruction and the certificate of the client is attached to the received e-mail, the determination unit 50 determines that the received e-mail includes the update instruction for the certificate 40. In this case, the determination unit 50 includes a storage unit (not illustrated) which stores the prescribed e-mail address exclusive for the update instruction. When the determination unit 50 determines that the received e-mail includes the update instruction, the accepting unit 52 acquires a new certificate attached to the received e-mail. The accepting unit 50 passes the acquired new certificate to the certificate updating unit 36.

Referring to FIG. 1 again, the certificate updating unit 36 updates the certificate 40 stored in the certificate storage unit 18 with the new certificate acquired by the accepting unit 52. When the certificate 40 stored in the certificate storage unit 18 is updated, the update notification e-mail generating unit 38 notifies that the certificate 40 has been updated. For example, the update notification e-mail generating unit 38 generates update completion notification e-mail for the account, which has updated the certificate 40, and stores the generated update completion notification e-mail into the e-mail box 22. That is, the update notification e-mail generating unit 38 generates the update completion notification e-mail, and stores the update completion notification e-mail into the e-mail box 22 of the account, which has updated the certificate 40. When the terminal 3 of the account accesses the e-mail box 22 by using a POP protocol, the terminal 3 can receive the update completion notification e-mail stored in the e-mail box 22 of the corresponding account.

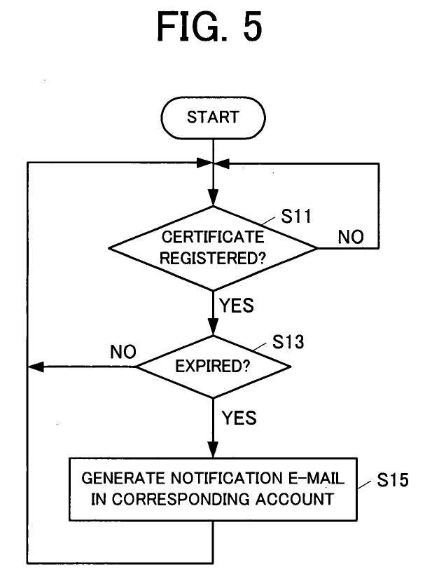

Next, a description will be made of an operation of the e-mail server device 10 configured as described above. First, a description will be made of an operation performed when confirming the expiration date 44 of the certificate 40 registered in the e-mail server device 10 of the present preferred embodiment. FIG. 5 is a flowchart illustrating an example of an operation performed for managing the expiration date 44 of the certificate 40 of the e-mail server device 10 of the present preferred embodiment. In the following, a description will be made with reference to FIG. 1 through FIG. 3 and FIG. 5.

First, the validity determination unit 32 accesses the certificate storage unit 18 of FIG. 2 and sequentially confirms for each account, whether or not the certificate 40 is registered (step S11). When the certificate 40 is registered (step S11: YES), the validity determination unit 32 acquires the certificate 40 (FIG. 3) registered in the certificate storage unit 18. The validity determination unit 32 acquires the present date and time from the clock 30 and compares the present date and time with the expiration date 44 of the certificate 40 to confirm whether or not the certificate 40 has expired (step S13).

When the certificate 40 has expired (step S13: YES), the validity determination unit 32 notifies the expiration of the certificate 40 to the update request e-mail generating unit 34. When the update request e-mail generating unit 34 receives a notification of the expiration, the update request e-mail generating unit 34 creates update request e-mail for notifying that the expiration date 44 of the certificate 40 has expired, and stores the update request e-mail into the e-mail box 22 of such an account (step S15). When the terminal 3 of the corresponding account accesses the e-mail box 22 via the POP unit 20, the terminal 3 receives the update request e-mail stored in the e-mail box 22. When the user receives this update request e-mail, the user can learn that the expiration date 44 of the certificate 40 has expired and take a measure to update the certificate 40, for example. Then, the process returns to step S11. The validity determination unit 32 repeats the process for confirming the certificate 40 for a next account registered in the certificate storage unit 18.

When the certificate 40 is not registered in the certificate storage unit 18 (step S11: NO), or when the expiration date 44 of the certificate 40 has not expired (step S13: NO), the process returns to step S11. The validity determination unit 32 repeats the process for confirming the certificate 40 for a next account registered in the certificate storage unit 18.

At step S13, instead of determining whether or not the expiration date 44 of the certificate 40 has expired, for example, the validity determination unit 32 may determine whether or not the present date and time is a prescribed number of days before the expiration date 44. That is, the validity determination unit 32 may determine whether or not a remaining number of days of the effective period is greater than the prescribed number of days. In case of such an example, the certificate 40 can be updated few days in advance before the expiration date 44 expires, not after the expiration date 44 has expired.

The update determination process of the certificate 40 as illustrated in FIG. 5 can be carried out periodically, for example, at prescribed time intervals or at a designated date and time. The update determination process can be carried out for a corresponding account at transmission and/or reception of e-mail. Alternatively, the update determination process can be carried out according to a request of a client or a server manager. In this case, the validity determination unit 32 is required to include an accepting unit (not illustrated) for accepting the request of the client or the server manager. As described above, the e-mail server device 10 according to the present preferred embodiment can automatically carry out the management of the expiration date 44 or the like of the digital certificate 40. Thus, the client is not required to carry out the management of the certificate 40. Accordingly, convenience and reliability of security improve.

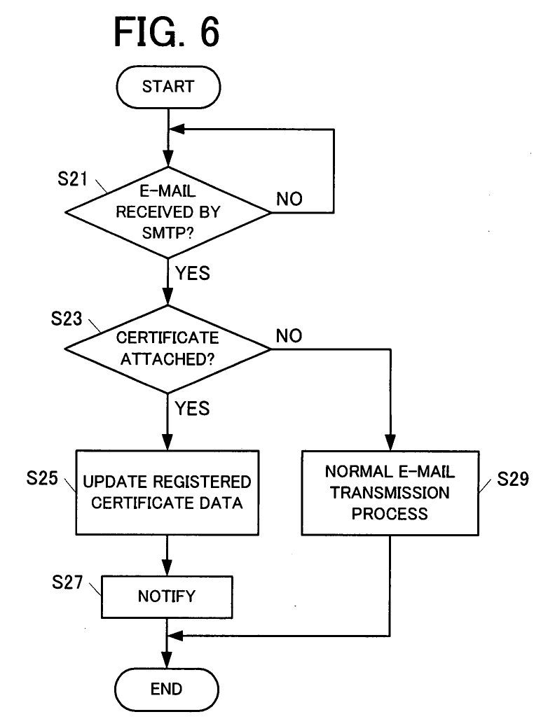

Next, a description will be made of an operation performed by the e-mail server device 10 at SMTP reception of transmission e-mail according to the present preferred embodiment of the present invention. FIG. 6 is a flowchart illustrating an example of an operation performed at SMTP reception of transmission e-mail by the e-mail server device 10 according to the present preferred embodiment of the present invention. In the following, a description will be made with reference to FIG. 1, FIG. 4 and FIG. 6.

First, the SMTP reception unit 14 receives e-mail transmitted from the terminal 3 on the LAN 7 via the LAN interface unit 12 (step S21: YES). Next, to determine whether or not the received e-mail includes an update instruction of the certificate 40, the determination unit 50 determines whether or not an account of a transmitter and an account of a destination in the received e-mail are the same and whether or not the certificate 40 of a client is attached to the received e-mail (step S23). That is, when the account of the transmitter and the account of the destination are the same in the received e-mail, and when the certificate 40 of the client is attached to the received e-mail, the determination unit 50 determines that the received e-mail is update instruction e-mail.

When the received e-mail is the update instruction e-mail (step S23: YES), the accepting unit 52 acquires a new certificate 40 from the received e-mail and passes the acquired new certificate 40 to the certificate updating unit 36. The certificate updating unit 36 stores the new certificate into the certificate storage unit 18 and updates the certificate 40 (step S25). Alternatively, the certificate updating unit 36 can newly register a new certificate with the certificate storage unit 18. Next, the update notification e-mail generating unit 38 creates notification e-mail for notifying that the certificate 40 has been updated and stores the created notification e-mail into the e-mail box 22 of a corresponding account (step S27). The terminal 3 on the LAN 7 accesses the e-mail box 22 via the POP unit 20 to receive the notification e-mail addressed to the corresponding account. Accordingly, the user can learn that the certificate 40 has been updated.

Further, as another determination method at step S23, a prescribed e-mail account can be previously registered as an account for an update instruction of the certificate 40, and the determination unit 50 can determine whether or not the received e-mail is addressed to the account for the update instruction and whether or not the certificate 40 of the client is attached to the received e-mail. That is, when the destination of the received e-mail is the account for the update instruction and the certificate 40 of the client is attached to the received e-mail, the determination unit 50 can determine that the received e-mail is the update instruction e-mail.

When the determination unit 50 determines at step S23 that the received e-mail is not the update instruction e-mail (step S23: NO), the received e-mail is passed to the signature unit 16 and a normal e-mail transmission process to be described later is executed (step S29). As described above, according to the present preferred embodiment, just by transmitting the e-mail with the digital signature from each client to the e-mail server device 10, the digital certificate 40 registered in the e-mail server device 10 can be updated automatically. As a result, usability improves.

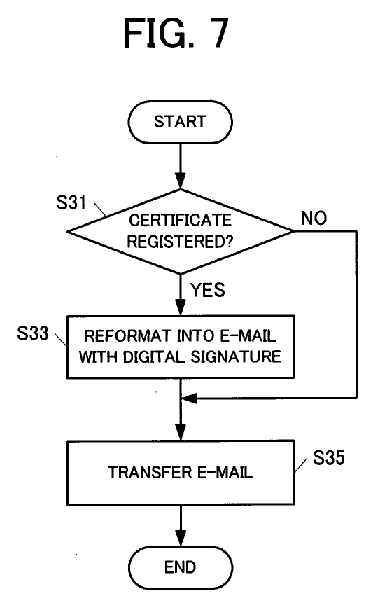

Next, a description will be made of an operation performed at transfer of transmission e-mail by the e-mail server device 10 according to the present preferred embodiment of the present invention. FIG. 7 is a flowchart illustrating an example of an operation performed at transfer of e-mail by the e-mail server device 10 according to a preferred embodiment of the present invention. In the following, a description will be made with reference to FIG. 1 and FIG. 7.

First, the signature unit 16 accesses the certificate storage unit 18, acquires certificate registration information corresponding to the account of the transmitter of the e-mail received by the SMTP reception unit 14, and determines whether or not the certificate 40 is registered (step S31). When the certificate 40 is registered (step S31: YES), the signature unit 16 adds a digital signature to the received e-mail to reformat the received e-mail (step S33). The signature unit 16 adds the digital signature by using the certificate 40 acquired from the certificate storage unit 18. Then, the SMTP transmission unit 24 transfers the reformatted received e-mail to the other e-mail server 5 (step S35).

As described above, according to the e-mail server device 10 of the present preferred embodiment of the present invention, the management of the expiration date or the like of the digital certificate can be carried out automatically. As a result, the client is not required to carry out a management of the certificate 40. The present preferred embodiment provides an e-mail server device having high convenience and highly reliably security.

A preferred embodiment of the present invention has been described with reference to the drawings. However, the above description is one example of the present invention. The present invention may adopt various other constitutions.

For example, in the above-described preferred embodiment, the validity determination unit 32 determines the validity of the digital certificate 40 in accordance with the expiration date of the digital certificate 40. However, the present invention is not limited to this example. For example, the validity determination unit 32 may determine the validity of the digital certificate 40 in accordance with a presence or an absence of a lapse of the digital certificate 40. The validity determination unit 32 may also determine the validity of the digital certificate 40 in accordance with a presence or an absence of a lapse of the digital certificate 40 and the expiration date of the digital certificate 40. In this example, the e-mail server device 10 preferably includes an inquiry unit (not illustrated) for inquiring a certificate authority as to information on the presence or the absence of the lapse of the digital certificate 40. The inquiry unit may use a prescribed protocol to inquire the certificate authority as to the presence or the absence of the lapse of the digital certificate 40, for example. Alternatively, the inquiry unit may request a lapse list from the certificate authority, and refer to the acquired lapse list to determine the presence or the absence of the lapse of the digital certificate 40.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. An e-mail server device, comprising:
a certificate storage unit which stores a certificate for each account;
a reception unit which receives e-mail;
a digital signature unit which assigns a digital signature to the e-mail received by the reception unit by using the certificate of an account of a transmitter;
a transfer unit which transfers the e-mail assigned with the digital signature;
a determination unit which determines whether or not to update the certificate stored in the certificate storage unit; and
an update requesting unit which transmits an update request e-mail to the account for requesting an update of the certificate when the determination unit determines that the update of the certificate is necessary.

2. The e-mail server device according to claim 1, wherein the determination unit determines whether or not to update the certificate according to whether the certificate stored in the certificate storage unit is valid or invalid.

3. The e-mail server device according to claim 2, wherein the determination unit determines whether the certificate is valid or invalid in accordance with an expiration date of the certificate.

4. The e-mail server device according to claim 2, wherein the determination unit determines whether the certificate is valid or invalid in accordance with a presence or an absence of a lapse of the certificate.

5. The e-mail server device according to claim 1, wherein the determination unit determines whether or not to update the certificate according to whether a remaining length of an effective period of the certificate stored in the certificate storage unit is a prescribed length or shorter.

6. The e-mail server device according to claim 5, wherein the determination unit determines whether or not the remaining length of the effective period of the certificate is the prescribed length or shorter in accordance with the expiration date of the certificate.

7. The e-mail server device according to claim 1, further comprising:
an update accepting unit which accepts an update instruction of the certificate by e-mail; and
an updating unit which updates the certificate stored in the certificate storage unit when the update accepting unit accepts the update instruction.

8. The e-mail server device according to claim 7, further comprising an update notification unit which transmits an update notification e-mail to the account for notifying that the updating unit has updated the certificate.

9. The e-mail server device according to claim 1, wherein the determination unit periodically determines whether or not to update the certificate.

10. The e-mail server device according to claim 1, wherein the determination unit determines whether or not to update the certificate when the reception unit receives the e-mail.

11. A certificate management method of an e-mail server device, comprising the steps of:
storing a certificate for each account;
receiving e-mail;
assigning a digital signature to the e-mail received at the receiving step by using the certificate of an account of a transmitter;
transferring the e-mail assigned with the digital signature;
determining whether or not to update the certificate stored at the storing step; and
requesting an update of the certificate by transmitting an update request e-mail to the account when a determination is made at the determining step that the certificate is necessary to be updated.

12. The certificate management method of the e-mail server device according to claim 11, wherein at the determining step, a determination is carried out as to whether or not to update the certificate stored at the storing step according to whether the certificate is valid or invalid.

13. The certificate management method of the e-mail server device according to claim 12, wherein at the determining step, a determination is carried out as to whether the certificate is valid or invalid in accordance with an expiration date of the certificate.

14. The certificate management method of the e-mail server device according to claim 12, wherein at the determining step, a determination is carried out as to whether the certificate is valid or invalid in accordance with a presence or an absence of a lapse of the certificate.

15. The certificate management method of the e-mail server device according to claim 11, wherein at the determining step, a determination is carried out as to whether or not to update the certificate stored at the storing step according to whether or not a remaining length of an effective period of the certificate is a prescribed length or shorter.

16. The certificate management method of the e-mail server device according to claim 15, wherein at the determining step, a determination is carried out as to whether or not the remaining length of the effective period of the certificate is the prescribed length or shorter in accordance with an expiration date of the certificate.

17. The certificate management method of the e-mail server device according to claim 11, further comprising the steps of:
accepting an update instruction of the certificate by e-mail; and
updating the certificate stored at the storing step when accepting the update instruction at the accepting step.

18. The certificate management method of the e-mail server device according to claim 17, further comprising the step of notifying that the certificate has been updated at the updating step by transmitting update notification e-mail to the account.

19. The certificate management method of the e-mail server device according to claim 11, wherein at the determining step, the determination as to whether or not to update the certificate is carried out periodically.

20. The certificate management method of the e-mail server device according to claim 11, wherein at the determining step, the determination as to whether or not to update the certificate is carried out when receiving the e-mail at the receiving step.
